(19) United States
(12) Patent Application Publication
(10) Pub. No.: US 2026/0219684 A1
(43) Pub. Date: Jul. 30, 2026

(54) APPARATUS, METHOD, AND PROGRAM

(71) Applicant: Yokogawa Electric Corporation, Tokyo (JP)

(72) Inventors: Hiroki SUGAWARA, Tokyo (JP); Yasuki SAKURAI, Tokyo (JP); Takeshi HATANAKA, Tokyo (JP); Yuya OKADA, Tokyo (JP)

(21) Appl. No.: 19/145,941

(22) PCT Filed: Dec. 28, 2023
(86) PCT No.: PCT/JP2023/047360

§ 371 Date: Jul. 6, 2025

(30) Foreign Application Priority Data
Jan. 13, 2023 (JP) 2023-003588

(51) Int. Cl. G05D 1/648; G05D 1/698

(52) U.S. Cl. CPC G05D 1/6482; G05D 1/6987

(57) ABSTRACT

Provided is an apparatus including: an area allocation unit which executes area allocation of allocating a plurality of robots to a plurality of areas, which are obtained by dividing a facility to be operated, based on specifications of the plurality of robots and requirements of a plurality of tasks to be executed in the facility; and a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots.

### TECHNICAL FIELD

The present invention relates to an apparatus, a method, and a program.

The contents of the following patent application(s) are incorporated herein by reference: NO. 2023-003588 filed in JP on Jan. 13, 2023

### BACKGROUND

Patent Document 1 describes “an autonomous multi-platform robot system”. Patent Document 2 describes “a system and method for optimizing scheduling of non-preemptive tasks in a multi-robot environment”.

### PRIOR ART DOCUMENTS

### Patent Documents

Patent Document 1: Japanese translation publication of a PCT rout patent application No. 2003-515801
Patent Document 2: Japanese Patent Application Publication No. 2020-149675

### GENERAL DISCLOSURE

In a first aspect of the present invention, an apparatus is provided. The apparatus includes: an area allocation unit which executes area allocation of allocating a plurality of robots to a plurality of areas, which are obtained by dividing a facility to be operated, based on specifications of the plurality of robots and requirements of a plurality of tasks to be executed in the facility; and a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots. The task allocation unit may execute the task allocation for the plurality of areas by parallel processing.

The apparatus may further include an intra-area path decision unit which decides an intra-area path, along which the target robot is moved in the target area, based on a result of the task allocation. The intra-area path decision unit may decide the intra-area path by performing parallel processing on a plurality of time slots and the plurality of areas.

Any one of the apparatuses may further include an inter-area path decision unit which decides an inter-area path, along which the plurality of robots are moved between areas among the plurality of areas, based on a result of the area allocation. The inter-area path decision unit may decide the inter-area path by performing parallel processing on the plurality of time slots and the plurality of areas.

In any one of the apparatuses, in the area allocation in one time slot, the area allocation unit may decide, for each of the plurality of robots, a start point position and an end point position in the one time slot based on results of the area allocation in other time slots.

In any one of the apparatuses, the intra-area path decision unit may decide the intra-area path in accordance with the start point position and the end point position in the one time slot. The intra-area path decision unit may decide the intra-area path so as to move the target robot from the start point position in the one time slot to the end point position via a position where each intra-area task allocated to the target robot is to be executed.

In any one of the apparatuses, the inter-area path decision unit may decide the inter-area path in accordance with the end point position in the one time slot and the start point position in a subsequent time slot.

Any one of the apparatuses may further include a feasibility determination unit which determines, based on specification information indicating specifications in one or more robots among the plurality of robots and task information indicating requirements of one or more tasks among the plurality of tasks, execution feasibility indicating whether the one or more robots are capable of executing the one or more tasks, and the area allocation unit may execute the area allocation based on the execution feasibility.

In any one of the apparatuses, the feasibility determination unit may determine, based on specification information indicating a specification in each of the plurality of robots and task information indicating requirements of the plurality of tasks, execution feasibility indicating whether each of the plurality of robots is capable of executing each of the plurality of tasks.

In any one of the apparatuses, the feasibility determination unit may determine the execution feasibility further based on environment information indicating environment of the facility for each area to which each of the plurality of tasks belongs.

Any one of the apparatuses may further include an operation plan output unit which outputs, as an operation plan, at least one of a result of the area allocation, a result of the task allocation, the intra-area path, or the inter-area path.

Any one of the apparatuses may further include an index output unit which outputs an index obtained by evaluating the operation plan in accordance with a predetermined criterion. The index output unit may output the index value obtained by evaluating the operation plan by using a predetermined evaluation formula or evaluation model.

Any one of the apparatuses may further include a robot change unit which changes at least one of a number or specifications of the plurality of robots based on an index obtained by evaluating the operation plan in accordance with a predetermined criterion, and the area allocation unit may reallocate, to the plurality of areas, a plurality of new robots of which at least one of the number or the specifications has been changed.

Any one of the apparatuses may further include an area change unit which changes at least one of a number of areas or a boundary of the plurality of areas based on an index obtained by evaluating the operation plan in accordance with a predetermined criterion, and the area allocation unit may reallocate the plurality of robots to a plurality of new areas of which at least one of the number of areas or the boundary has been changed.

Any one of the apparatuses may further include a control unit which controls the plurality of robots in accordance with the operation plan.

In a second aspect of the present invention, a method is provided. The method performed by a computer includes: executing area allocation of allocating a plurality of robots to a plurality of areas, which are obtained by dividing a facility to be operated, based on specifications of the plurality of robots and requirements of a plurality of tasks to be executed in the facility; and executing, for a target area which is each of the plurality of areas, task allocation of allocating an intra-area task, which is at least one task belonging to the target area among the plurality of tasks, to a target robot which is at least one robot allocated to the target area among the plurality of robots.

In a third aspect of the present invention, a program is provided. The program is executed by a computer, and causes the computer to function as: an area allocation unit which executes area allocation of allocating a plurality of robots to a plurality of areas, which are obtained by dividing a facility to be operated, based on specifications of the plurality of robots and requirements of a plurality of tasks to be executed in the facility; and a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots.

The summary clause does not necessarily describe all necessary features of the embodiments of the present invention. The present invention may also be a sub-combination of the features described above.

### BRIEF DESCRIPTION OF THE DRAWINGS

FIG. 1 illustrates an example of a block diagram of an apparatus 100 according to the present embodiment together with a facility 10 to be operated.

FIG. 2 illustrates an example of various types of information stored in the apparatus 100 according to the present embodiment.

FIG. 3 illustrates an example of a result of area allocation executed by the apparatus 100 according to the present embodiment.

FIG. 4 illustrates an example of a result of task allocation executed by the apparatus 100 according to the present embodiment.

FIG. 5 illustrates an example of an intra-area path decided by the apparatus 100 according to the present embodiment.

FIG. 6 illustrates an example of an inter-area path decided by the apparatus 100 according to the present embodiment.

FIG. 7 illustrates an example of a flow diagram of a method executed by the apparatus 100 according to the present embodiment.

FIG. 8 illustrates an example of a block diagram of the apparatus 100 according to a first modification of the present embodiment together with the facility 10 to be operated.

FIG. 9 illustrates an example of a block diagram of the apparatus 100 according to a second modification of the present embodiment together with the facility 10 to be operated.

FIG. 10 illustrates an example of a block diagram of the apparatus 100 according to a third modification of the present embodiment together with the facility 10 to be operated.

FIG. 11 illustrates an example of a flow diagram of a method executed by the apparatus 100 according to the third modification of the present embodiment for repeatedly constructing an operation plan.

FIG. 12 illustrates an example of a block diagram of the apparatus 100 according to a fourth modification of the present embodiment together with the facility 10 to be operated.

FIG. 13 illustrates an example of a computer 9900 in which a plurality of aspects of the present invention may be embodied in whole or in part.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the means for solving the problems of the invention.

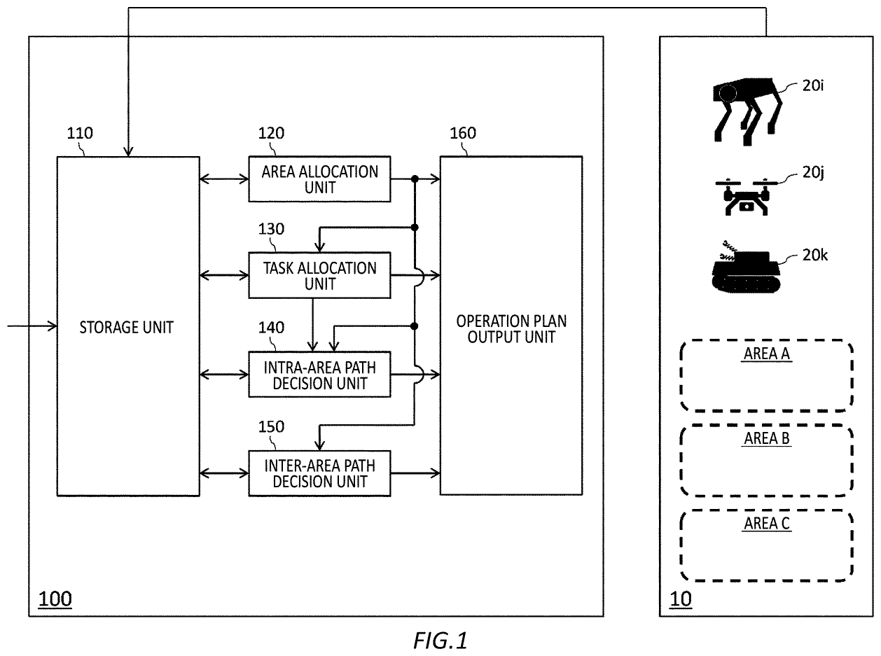

FIG. 1 illustrates an example of a block diagram of an apparatus 100 according to the present embodiment together with a facility 10 to be operated. Note that, these blocks are functional blocks that are each functionally divided, and may not be necessarily required to be matched with actual apparatus configurations. In other words, in the present figure, a unit shown as one block does not necessarily need to be configured by one device. Also, in the present figure, units shown as separate blocks do not necessarily need to be configured by separate devices. The same applies to other block diagrams.

The facility 10 is equipment, an apparatus, a building, or the like to be operated. For example, the facility 10 may be a plant. Examples of the plant may include a plant for managing and controlling wells such as a gas field and an oil field and surroundings thereof, a plant for managing and controlling hydroelectric, thermal and nuclear power generations and the like, a plant for managing and controlling environmental power generation such as solar power and wind power, a plant for managing and controlling water and sewerage, a dam, and the like, etc., in addition to chemical and bio industrial plants and the like.

In such a facility 10, expectations for robot introduction are increasing due to problems such as a shortage of human resources, safety at the time of work, and maintenance cost, and development of a wide variety of robots having different specifications is progressing. Among the robots under development or already developed, there are robots which can autonomously move and robots which can execute tasks without human intervention. It has been studied to at least partially operate the facility 10 by a multi-robot system in which a plurality of such robots are introduced.

A robot 20 is introduced into the facility 10 and executes various tasks related to the operation of the facility 10. In the present figure, a case where three robots 20 of a robot 20i, a robot 20j, and a robot 20k (collectively referred to as a “robot(s) 20”) are introduced into the facility 10 is illustrated as an example.

For example, the robot 20i may be a robot capable of autonomous travel using quadruped walking. In addition, for example, the robot 20i may be capable of measuring surrounding sound with a mounted microphone and capable of imaging an imaging target with a mounted camera. In addition, the robot 20i may be movable at, for example, 5 km/h. In addition, for example, the robot 20i may be capable of continuous operation for 3 hours when the battery is fully charged. In addition, the robot 20i may be capable of climbing over a step of 20 cm or less, for example.

For example, the robot 20j may be a robot (a drone, a multicopter, or the like) capable of autonomous flight using rotary wings. In addition, the robot 20j may be capable of measuring the temperature of a measurement target with a mounted thermo camera and capable of imaging an imaging target with a mounted camera. In addition, the robot 20j may be movable at, for example, 10 km/h. In addition, for example, the robot 20j may be capable of continuous operation for 5 hours when the battery is fully charged.

For example, the robot 20k may be a robot capable of autonomous travel using a caterpillar. In addition, for example, the robot 20k may be capable of measuring surrounding sound with a mounted microphone and capable of operating an operation instrument (a valve or the like) with a mounted arm. In addition, the robot 20k may be movable at, for example, 3 km/h. In addition, the robot 20k may be capable of continuous operation for 2 hours when the battery is fully charged. In addition, for example, the robot 20k may have anti-explosion resistance. In addition, the robot 20k may be capable of climbing over a step of 50 cm or less, for example.

As described above, a plurality of a wide variety of robots 20 having different specifications may be introduced into the facility 10. Note that, in the above description, a case where three robots 20, such as the robot 20i, the robot 20j, and the robot 20k, having different specifications are introduced into the facility 10 has been described as an example. However, the number and specifications of the robots 20 introduced into the facility 10 are not limited thereto, and a multi-robot system may be constituted by various combinations of various robots 20. In this case, for example, a plurality of robots to be introduced into the facility 10 may include a plurality of robots having the same specification.

When the facility 10 is operated by the multi-robot system, it is necessary to construct an operation plan. However, in constructing such an operation plan, it is necessary to consider various elements such as specifications of a wide range of robots, requirements of a wide variety of tasks, and restrictions due to the environment of the facility 10. Therefore, constructing the operation plan based on people or rules requires considerable man-hours, and may cause a problem that the constructed plan is inefficient, and a problem that an inexecutable task is allocated to the robot 20.

Conventionally, a method using an optimization technique has been established for such a problem, and it is known to construct an optimization problem based on various elements described above, planning strategies, and the like, and solve the optimization problem to obtain a desired operation plan. However, solving the problem of the operation plan involving the multi-robot system is considered a task, called non-deterministic polynomial time (NP) hard, which requires extremely high calculation cost, and it is impractical to put into operation. In addition, the calculation cost also depends on the scale of the facility 10 and the number of robots 20 to be introduced, and for example, when a large number of the robots 20 are introduced into a large scale of the facility 10 such as a plant, it is expected that merely implementing a method for reducing a calculation load and obtaining an approximate solution is not sufficient to reach an operational status.

In this regard, the apparatus 100 according to the present embodiment divides processing into area allocation, task allocation, intra-area path decision, and inter-area path decision. Thus, according to the apparatus 100 according to the present embodiment, it is possible to solve the problem of the operation plan involving a plurality of the robots 20 at high speed and construct a practical operation plan in a practical calculation time regardless of the scale of the facility 10 and the number of robots 20. Such an apparatus 100 will be described in detail.

The apparatus 100 includes a storage unit 110, an area allocation unit 120, a task allocation unit 130, an intra-area path decision unit 140, an inter-area path decision unit 150, and an operation plan output unit 160.

The storage unit 110 stores various types of information for constructing the operation plan. Such information may be acquired from the facility 10 or an external system via a network, may be acquired via user input, or may be acquired via various memory devices. Details of the information stored in the storage unit 110 will be described later.

The area allocation unit 120 executes area allocation of allocating the plurality of robots 20 to a plurality of areas, which are obtained by dividing the facility 10 to be operated, based on the specifications of the plurality of robots 20 and the requirements of a plurality of tasks to be executed in the facility 10. The area allocation unit 120 supplies the result of the area allocation to the task allocation unit 130, the intra-area path decision unit 140, the inter-area path decision unit 150, and the operation plan output unit 160.

For a target area which is each of the plurality of areas, the task allocation unit 130 executes task allocation of allocating an intra-area task, which is at least one task belonging to the target area among the plurality of tasks, to a target robot which is at least one robot allocated to the target area among the plurality of robots 20. The task allocation unit 130 supplies the result of the task allocation to the intra-area path decision unit 140 and the operation plan output unit 160.

The intra-area path decision unit 140 decides an intra-area path, along which the target robot is moved within the target area, based on the result of the task allocation. The intra-area path decision unit 140 supplies the decided intra-area path to the operation plan output unit 160.

The inter-area path decision unit 150 decides an inter-area path, along which the plurality of robots 20 are moved between areas among the plurality of areas, based on the result of the area allocation. The inter-area path decision unit 150 supplies the decided inter-area path to the operation plan output unit 160.

The operation plan output unit 160 outputs, as the operation plan, at least one of the result of the area allocation, the result of the task allocation, the intra-area path, or the inter-area path. The operation plan output unit 160 may be, for example, a monitor, and may display and output the operation plan. Alternatively or in addition, the operation plan output unit 160 may be a communication unit, and may transmit and output the operation plan to another functional unit or another apparatus. Alternatively or in addition, the operation plan output unit 160 may be a printer, and may print out the operation plan. Alternatively or in addition, the operation plan output unit 160 may be a speaker and may output the operation plan by voice.

The apparatus 100 including such a functional unit may be a computer such as a personal computer (PC), a tablet computer, a smartphone, a workstation, a server computer, or a general-purpose computer, or may be a computer system in which a plurality of computers are connected. Such a computer system is also a computer in a broad sense. In addition, the apparatus 100 may also be implemented by one or more virtual computer environments executable in a computer. Alternatively, the apparatus 100 may be a dedicated computer customized to provide the above-described functions, or may be dedicated hardware realized by a dedicated circuit. In addition, when connection to the Internet is possible, the apparatus 100 may be realized by cloud computing.

Such a computer may include a memory which stores a program and a processor which executes the program, and a function as the apparatus 100 may be implemented by the processor executing the program. That is, there is also provided a program that, when executed by a computer, causes the computer to function as: an area allocation unit which executes area allocation of allocating the plurality of robots 20 to a plurality of areas, which are obtained by dividing the facility 10 to be operated, based on specifications of the plurality of robots 20 and requirements of a plurality of tasks to be executed in the facility 10; and a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots 20. In addition, a non-transitory computer readable medium having recorded thereon such a program is also provided.

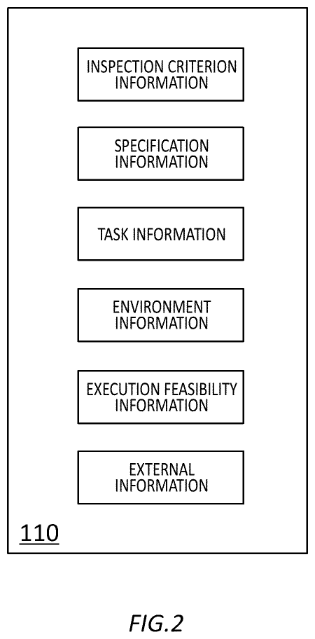

FIG. 2 illustrates an example of various types of information stored in the apparatus 100 according to the present embodiment. The storage unit 110 may store, for example, inspection criterion information, specification information, task information, environment information, execution feasibility information, and external information.

The inspection criterion information is information indicating an inspection criterion set in advance. As an example, the inspection criterion information may include information such as an inspection type, an importance level, a quality determination criterion, and necessity of attendance of a person in charge of maintenance.

The specification information is information indicating a specification in each of the plurality of robots 20. As an example, the specification information may include information such as a moving means, a mounted sensor (measurable physical quantity), a mounted arm, a moving speed, a continuous operation time, a remaining battery amount, a climbable step, anti-explosion resistance, and the number of tasks which can be executed per unit time in each of the plurality of robots 20. Here, the continuous operation time may indicate the time, for which the continuous operation is possible, estimated based on the rated full charge capacity of the battery, or may indicate the time, for which the continuous operation is possible, estimated based on the full charge capacity at the time of deterioration of the battery in consideration of a state of health (SOH). In addition, the remaining battery amount may indicate a ratio of the current battery charge capacity to the rated full charge capacity of the battery, that is, a state of charge (SOC), or may indicate a ratio of the current battery charge capacity to the full charge capacity at the time of deterioration of the battery in consideration of the SOH.

The task information is information indicating the requirements of a plurality of tasks to be executed in the facility 10. As an example, the task information may include information such as a position, a deadline, a period, an item, a procedure, a target meter, and a target operation instrument in each of the plurality of tasks.

The environment information is information indicating the environment of the facility 10. As an example, the environment information may include information such as a 3D map, temperature, humidity, gas concentration, and radiation dose at each of a plurality of points of the facility 10.

The execution feasibility information is information indicating whether each of the plurality of robots 20 can execute each of the plurality of tasks. In the present embodiment, such execution feasibility information may be manually created in advance in consideration of the specifications of the robot 20, the requirements of the task, the environment of the facility 10, and the like.

The external information is information indicating a disturbance that can influence the construction of the operation plan. As an example, the external information may include a maintenance plan, weather, outside temperature, disaster information, and the like.

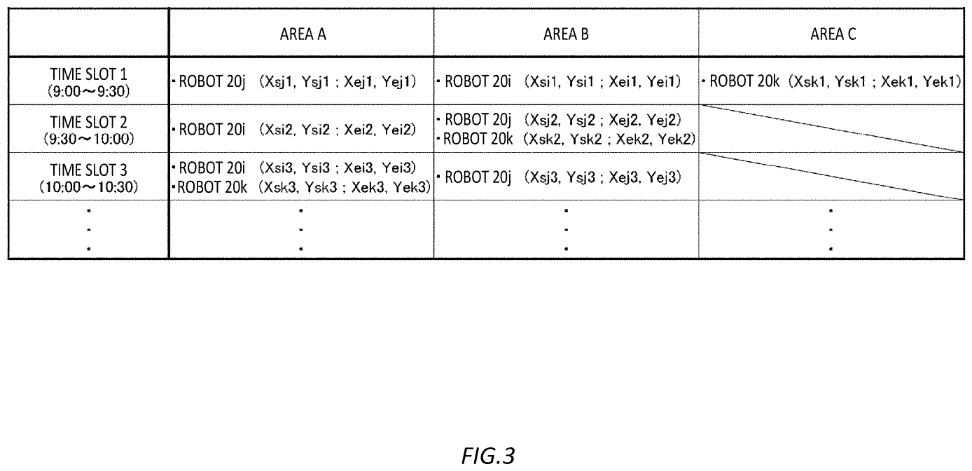

FIG. 3 illustrates an example of a result of area allocation executed by the apparatus 100 according to the present embodiment. In the present figure, as an example, it is illustrated that the robot 20j is allocated to an area A in a time slot 1 (9:00 to 9:30). In addition, in the present figure, as an example, it is illustrated that the robot 20j and the robot 20k are allocated to an area B in a time slot 2 (9:30 to 10:00). In addition, in the present figure, as an example, it is illustrated that no robot 20 is allocated to an area C in a time slot 3 (10:00 to 10:30).

As described above, the area allocation unit 120 may allocate the plurality of robots 20 to the plurality of areas for each predetermined time slot. At this time, the area allocation unit 120 does not necessarily allocate each of the plurality of robots 20 to any of the plurality of areas. For example, the robot 20k has a continuous operation time of 2 hours. In this case, when the robot 20k starts the operation from 9:00, it is predicted to run out of battery at 11:00. In such a case, the area allocation unit 120 may execute area allocation such that the robot 20k is charged without being allocated to any area in a time slot 4 (10:30 to 11:00), for example.

In addition, in the area allocation in one time slot, the area allocation unit 120 may decide, for each of the plurality of robots 20, a start point position s and an end point position e in the one time slot based on the results of the area allocation in other time slots. As an example, focusing on the robot 20k, in the present figure, “Xsk1” indicates the X coordinate of a start point position sk1 of the robot 20k in the time slot 1. Similarly, “Ysk1” indicates the Y coordinate of the start point position sk1 of the robot 20k in the time slot 1. In addition, “Xek1” indicates the X coordinate of an end point position ek1 of the robot 20k in the time slot 1. Similarly, “Yek1” indicates the Y coordinate of the end point position ek1 of the robot 20k in the time slot 1.

The robot 20k is allocated to the area C in the time slot 1, allocated to the area B in the time slot 2, and allocated to the area A in the time slot 3. That is, when the robot 20k transitions from the time slot 1 to the time slot 2, movement between the areas from the area C to the area B occurs. Similarly, when the robot 20k transitions from the time slot 2 to the time slot 3, movement between the areas from the area B to the area A occurs.

In such a case, it is preferable that the end point position ek1 of the robot 20k in the time slot 1 and a start point position sk2 of the robot 20k in the time slot 2 are in the vicinity. Similarly, it is preferable that an end point position ek2 of the robot 20k in the time slot 2 and a start point position sk3 of the robot 20k in the time slot 3 are in the vicinity.

Therefore, the area allocation unit 120 may decide the coordinates (Xek1, Yek1) of the end point position ek1 and the coordinates (Xsk2, Ysk2) of the start point position sk2 such that the end point position ek1 and the start point position sk2 are close to each other. Similarly, the area allocation unit 120 may decide the coordinates (Xek2, Yek2) of the end point position ek2 and the coordinates (Xsk3, Ysk3) of the start point position sk3 such that the end point position ek2 and the start point position sk3 are close to each other. That is, the area allocation unit 120 may decide the coordinates of an end point position e(n−1) in a time slot (n−1) and the coordinates of a start point position s(n) in a time slot (n) such that a distance between the end point position e(n−1) in the time slot (n−1) and the start point position s(n) in the time slot (n) is equal to or less than a predetermined threshold (preferably, minimal).

In the case of the beginning or end of time slots with no immediately preceding or following time slot, the area allocation unit 120 may decide the coordinates of the start point position s and the coordinates of the end point position e such that a distance from an arbitrary position, for example, a standby position (a charging station or the like) of the robot 20 or the like is equal to or less than a predetermined threshold (preferably, minimal).

The area allocation unit 120 may execute such area allocation by various existing algorithms based on the specifications of the plurality of robots 20 and the requirements of the plurality of tasks (for example, based on the execution feasibility information). As an example, the area allocation unit 120 may execute the area allocation by an integer programming method. In this case, the area allocation unit 120 may execute the area allocation so as to maximize an objective function. At this time, the area allocation unit 120 may set the objective function such that the larger the amount (number) of tasks to be achieved, the larger the value. In addition, the area allocation unit 120 may set the objective function such that the larger a movement distance between areas, the smaller the value. Note that, the movement distance between areas is confirmed in inter-area path decision processing at the subsequent stage, and is not confirmed at this time. Therefore, the area allocation unit 120 may decide the movement distance between areas based on a provisional distance which is pre-defined based on the movement from which area to which area.

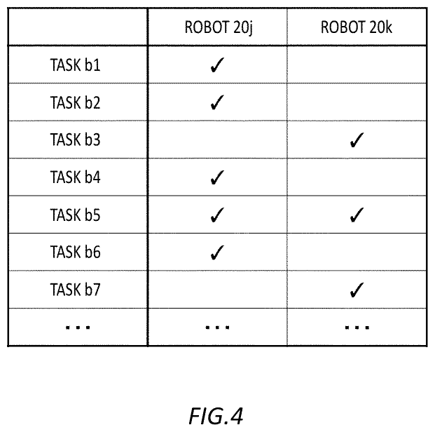

FIG. 4 illustrates an example of a result of task allocation executed by the apparatus 100 according to the present embodiment. The present figure illustrates, as an example, task allocation of an area B in the time slot 2. As described above, in the time slot 2, the robot 20j and the robot 20k are allocated to the area B. In this case, the area B is a target area, and the robot 20j and the robot 20k are defined as target robots. In such a case, the task allocation unit 130 allocates intra-area tasks b1 to bn, which belong to the area B which is the target area among the plurality of tasks, to the robot 20j and the robot 20k which are the target robots among the plurality of robots 20.

In the present figure, as an example, it is illustrated that the tasks b1, b2, b4, b5, and b6 are allocated to the robot 20j, and the tasks b3, b5, and b7 are allocated to the robot 20k. Note that, the task b5 is allocated to both the robot 20j and the robot 20k. For example, this may occur in a case where the task b5 is a multi-task such as measuring the temperature of the pipe when opening and closing the valve. In such a case, the task allocation unit 130 can allocate the task of opening and closing the valve in the task b5 to the robot 20k mounted with an arm, and allocate the task of measuring the temperature of the pipe in the task b5 to the robot 20j mounted with a thermo camera. The task allocation unit 130 may allocate a common task to a plurality of robots 20 in this manner, for example.

The task allocation unit 130 may execute such task allocation by various existing algorithms based on the specifications of the plurality of robots 20 and the requirements of the plurality of tasks (for example, based on the execution feasibility information). As an example, similarly to the area allocation unit 120, the task allocation unit 130 may execute the task allocation by an integer programming method.

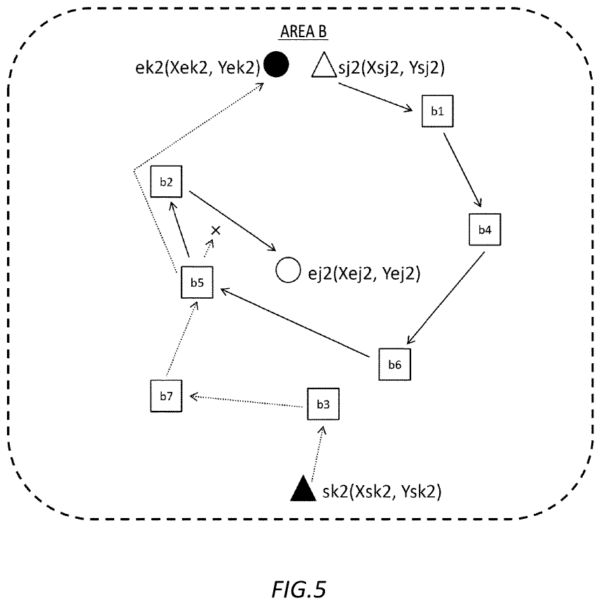

FIG. 5 illustrates an example of an intra-area path decided by the apparatus 100 according to the present embodiment. The present figure illustrates, as an example, an intra-area path of the area B in the time slot 2.

In the present figure, a white triangle indicates a start point position sj2 of the robot 20j in the time slot 2. As described above, the coordinates of the start point position sj2 are decided as (Xsj2, Ysj2). In addition, in the present figure, a white circle indicates an end point position ej2 of the robot 20j in the time slot 2. As described above, the coordinates of the end point position ej2 are decided as (Xej2, Yej2). In addition, as the tasks of the robot 20j in the time slot 2, the tasks b1, b2, b4, b5, and b6 are allocated as described above.

In this case, the intra-area path decision unit 140 may decide the intra-area path of the robot 20j in the time slot 2 in accordance with the start point position sj2 and the end point position ej2, and the position of each of the tasks b1, b2, b4, b5, and b6. In the present figure, a solid arrow indicates the intra-area path of the robot 20j in the time slot 2. In the present figure, as an example, it is illustrated that in the time slot 2, the robot 20j is to move along the path of the start point position sj2→the task b1→the task b4→the task b6→the task b5→the task b2→the end point position ej2.

The intra-area path decision unit 140 may decide such an intra-area path in accordance with a predetermined rule. As an example, the intra-area path decision unit 140 may decide the intra-area path in accordance with a rule of sequentially passing through the position of the closest task, such that the task b1 closest from the start point position sj2→the task b4 closest from the task b1→ . . . the task b2 to the end point position ej2. However, the present invention is not limited to this. The intra-area path decision unit 140 may decide the intra-area path in accordance with another rule. As an example, the intra-area path decision unit 140 may decide the intra-area path in accordance with a rule that the total distance of the intra-area path is to be equal to or less than a predetermined threshold (preferably, to be minimal). For example, in this manner, the intra-area path decision unit 140 may decide the intra-area path in accordance with the start point position s and the end point position e in one time slot.

Similarly, in the present figure, a black triangle indicates the start point position sk2 of the robot 20k in the time slot 2. As described above, the coordinates of the start point position sk2 are decided as (Xsk2, Ysk2). In addition, in the present figure, a black circle indicates the end point position ek2 of the robot 20k in the time slot 2. As described above, the coordinates of the end point position ek2 are decided as (Xek2, Yek2). In addition, as the tasks of the robot 20k in the time slot 2, the tasks b3, b5, and b7 are allocated as described above.

In this case, the intra-area path decision unit 140 may decide the intra-area path of the robot 20k in the time slot 2 in accordance with the start point position sk2 and the end point position ek2, and the position of each of the tasks b3, b5, and b7. In the present figure, a dotted arrow indicates the intra-area path of the robot 20k in the time slot 2. In the present figure, as an example, it is illustrated that in the time slot 2, the robot 20k is to move along the path of the start point position sk2→the task b3→the task b7→the task b5→the end point position ek2.

As described above, the task b5 is allocated to both the robot 20j and the robot 20k. In such a case, the intra-area path decision unit 140 may decide each of the intra-area paths of the robot 20j and the robot 20k such that the robot 20j and the robot 20k are positioned at the position of the task b5 at the same time. As an example, when a common task is allocated to a plurality of target robots, the intra-area path decision unit 140 may decide each of the intra-area paths of the plurality of target robots such that the value of a cost function having, as a cost, a waiting time for waiting for arrival of another target robot among the plurality of target robots at the position of the common task becomes small (preferably, minimal).

In addition, in the present figure, a cross mark indicates the possibility of collision between a plurality of target robots. As an example, there is a possibility that a path along which the robot 20j moves from the position of the task b2 to the end point position ej2 and a path along which the robot 20k moves from the position of the task b5 to the end point position ek2 cross each other and the robot 20j and the robot 20k pass through the intersection at the same timing. In such a case, for example, the intra-area path decision unit 140 may change the path, along which the robot 20k moves from the position of the task b5 to the end point position ek2, to a path which does not intersect the path along which the robot 20j moves from the position of the task b2 to the end point position ej2. Note that, in the above description, a case where the intra-area path decision unit 140 changes the path of any one of the robots 20 such that the paths of the plurality of target robots do not intersect with each other has been described as an example, but the present invention is not limited thereto. Even when the paths of the plurality of target robots cross each other, as long as the timing of passing through the intersection is different, there is no possibility of collision. Therefore, the intra-area path decision unit 140 may change such that any one of the target robots is caused to stand by so that the plurality of target robots pass through the intersection at different timings. For example, in this manner, for each of the plurality of target robots, the intra-area path decision unit 140 may decide the intra-area path so as to avoid collision with each other. Note that, when the movement altitudes of the plurality of target robots are different from each other and there is no possibility of collision, the intra-area path decision unit 140 may not execute collision avoidance.

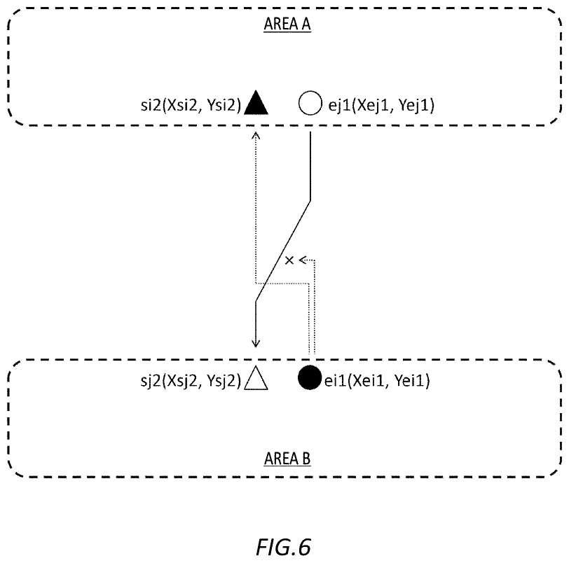

FIG. 6 illustrates an example of an inter-area path decided by the apparatus 100 according to the present embodiment. The present figure illustrates, as an example, an inter-area path between the area A and the area B between the time slot 1 and the time slot 2.

In the present figure, a white circle indicates an end point position ej1 of the robot 20j in the time slot 1. As described above, the coordinates of the end point position ej1 are decided as (Xej1, Yej1). In addition, in the present figure, a white triangle indicates the start point position sj2 of the robot 20j in the time slot 2. As described above, the coordinates of the start point position sj2 are decided as (Xsj2, Ysj2).

In this case, the inter-area path decision unit 150 may decide the inter-area path of the robot 20j between the time slot 1 and the time slot 2 in accordance with the end point position ej1 in the time slot 1 and the start point position sj2 in the time slot 2. In the present figure, a solid arrow indicates the inter-area path of the robot 20j between the time slot 1 and the time slot 2.

The inter-area path decision unit 150 may decide such an inter-area path in accordance with a predetermined rule. As an example, the inter-area path decision unit 150 may specify an obstacle, which may obstruct the movement of the robot 20j, in light of the moving means of the robot 20j based on the specification information and the environment information. Then, the inter-area path decision unit 150 may decide the inter-area path avoiding the specified obstacle in accordance with a rule that a distance from the end point position ej1 to the start point position sj2 is to be equal to or less than a predetermined threshold (preferably, to be minimal). For example, in this manner, the inter-area path of the robot 20j between the time slot 1 and the time slot 2 may be decided. However, the present invention is not limited to this. The inter-area path decision unit 150 may decide the inter-area path in accordance with another rule. For example, in this manner, the inter-area path decision unit 150 may decide the inter-area path in accordance with the end point position e in one time slot and the start point position s in the subsequent time slot.

Similarly, in the present figure, a black circle indicates an end point position ei1 of the robot 20i in the time slot 1. As described above, the coordinates of the end point position ei1 are decided as (Xei1, Yei1). In addition, in the present figure, a black triangle indicates a start point position si2 of the robot 20i in the time slot 2. As described above, the coordinates of the start point position si2 are decided as (Xsi2, Ysi2).

In this case, the inter-area path decision unit 150 may decide the inter-area path of the robot 20i between the time slot 1 and the time slot 2 in accordance with the end point position ei1 in the time slot 1 and the start point position si2 in the time slot 2. In the present figure, a dotted arrow indicates the inter-area path of the robot 20i between the time slot 1 and the time slot 2.

In addition, in the present figure, a cross mark indicates the possibility of collision between a plurality of robots 20 moving between the same areas. As an example, there is a possibility that a path along which the robot 20j moves from the end point position ej1 to the start point position sj2 and a path along which the robot 20i moves from the end point position ei1 to the start point position si2 cross each other and the robot 20j and the robot 20i pass through the intersection at the same timing. In such a case, the inter-area path decision unit 150 may change the path of the robot 20i such that the plurality of robots pass through the intersection at different timings. Note that the collision avoidance in the inter-area path decision unit 150 may also be executed in accordance with various rules, similarly to the intra-area path decision unit 140. For example, in this manner, for each of the plurality of robots 20, the inter-area path decision unit 150 may decide the inter-area path so as to avoid collision with each other.

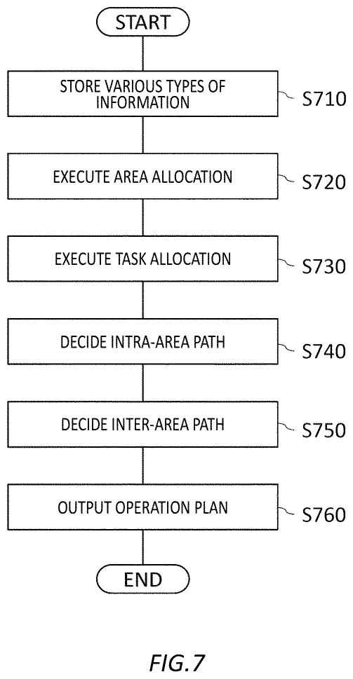

FIG. 7 illustrates an example of a flow diagram of a method executed by the apparatus 100 according to the present embodiment. Each step in the method may be executed by a computer as an operation subject. However, in each step, it is sufficient that the computer is the operation subject as a whole, and a case may be included in which a part other than the computer executes a part which is not a main part. The same applies to other flow diagrams.

In step S710, the apparatus 100 stores various types of information. For example, the storage unit 110 may store various types of information for constructing the operation plan. As an example, the storage unit 110 may store inspection criterion information, specification information, task information, environment information, execution feasibility information, and external information as illustrated in FIG. 2. Note that, in the present embodiment, the storage unit 110 may store, as the execution feasibility information, information manually created in advance in consideration of the specifications of the robot 20, the requirements of the task, the environment of the facility 10, and the like.

In step S720, the apparatus 100 executes area allocation. For example, the area allocation unit 120 may execute area allocation of allocating a plurality of robots 20 to a plurality of areas, which are obtained by dividing the facility 10 to be operated, based on at least a part of the various types of information stored in step S710, for example, the execution feasibility information and based on specifications of the plurality of robots 20 and the requirements of a plurality of tasks to be executed in the facility 10. As an example, as illustrated in FIG. 3, the area allocation unit 120 may allocate the robot 20j to the area A, allocate the robot 20i to the area B, and allocate the robot 20k to the area C in the time slot 1. In addition, the area allocation unit 120 may allocate the robot 20i to the area A, and allocate the robot 20j and the robot 20k to the area B in the time slot 2. In addition, the area allocation unit 120 may allocate the robot 20i and the robot 20k to the area A and allocate the robot 20j to the area B in the time slot 3.

At this time, the area allocation unit 120 may not only decide which robot 20 to allocate to which area for each time slot as described above, but also, in the area allocation in one time slot, decide, for each of the plurality of robots 20, the start point position s and the end point position e in the one time slot based on the results of the area allocation in other time slots. The area allocation unit 120 supplies the result of the area allocation to the task allocation unit 130, the intra-area path decision unit 140, the inter-area path decision unit 150, and the operation plan output unit 160.

In step S730, the apparatus 100 executes task allocation. For example, for a target area which is each of the plurality of areas, the task allocation unit 130 may execute task allocation of allocating an intra-area task, which is at least one task belonging to the target area among the plurality of tasks, to a target robot which is at least one robot allocated to the target area among the plurality of robots 20. As an example, as illustrated in FIG. 4, the task allocation unit 130 may allocate the tasks b1, b2, b4, b5, b6, and b7 to the robot 20j and allocate the tasks b3, b5, and b7 to the robot 20k in the area B in the time slot 2.

The task allocation unit 130 may similarly execute the task allocation for other time slots and other areas. Note that such task allocations for other areas are completely independent of each other, and the respective results do not affect each other at all. Therefore, the task allocation unit 130 can process the task allocations for the plurality of areas in parallel. The task allocation unit 130 supplies the result of the task allocation to the intra-area path decision unit 140 and the operation plan output unit 160.

In step S740, the apparatus 100 decides an intra-area path. For example, the intra-area path decision unit 140 may decide the intra-area path, along which the target robot is moved in the target area, based on the result of the task allocation executed in step S730. As an example, for the area B in the time slot 2, the intra-area path decision unit 140 may decide the intra-area path of the robot 20j such that the robot 20j is moved along the path indicated by the solid arrow illustrated in FIG. 5. Similarly, the intra-area path decision unit 140 may decide the intra-area path of the robot 20k such that the robot 20k is moved along the path indicated by the dotted arrow illustrated in FIG. 5. At this time, as described above, the intra-area path decision unit 140 may decide the intra-area path in accordance with the start point position s and the end point position e in one time slot. In addition, as described above, for each of the plurality of target robots, the intra-area path decision unit 140 may decide the intra-area path so as to avoid collision with each other.

The intra-area path decision unit 140 may similarly decide an intra-area path for other time slots and other areas. Note that such decisions of the intra-area path for such other time slots and other areas are completely independent of each other, and the respective results do not affect each other at all. Therefore, the intra-area path decision unit 140 can process the decision of the intra-area paths for a plurality of time slots and a plurality of areas in parallel. The intra-area path decision unit 140 supplies the intra-area path to the operation plan output unit 160.

In step S750, the apparatus 100 decides an inter-area path. For example, the inter-area path decision unit 150 may decide an inter-area path, along which the plurality of robots 20 are moved between areas among the plurality of areas, based on the area allocation executed in step S720. As an example, between the area A and the area B between the time slot 1 and the time slot 2, the inter-area path decision unit 150 may decide the inter-area path of the robot 20j such that the robot 20j is moved along the path indicated by the solid arrow illustrated in FIG. 6. Similarly, the inter-area path decision unit 150 may decide the inter-area path of the robot 20i such that the robot 20i is moved along the path indicated by the dotted arrow illustrated in FIG. 6. At this time, as described above, the inter-area path decision unit 150 may decide the inter-area path in accordance with the end point position e in one time slot and the start point position s in the subsequent time slot. In addition, as described above, for each of the plurality of robots 20, the inter-area path decision unit 150 may decide the inter-area path so as to avoid collision with each other.

The inter-area path decision unit 150 may similarly decide an inter-area path between other time slots and between other areas. Note that such decisions of the inter-area path between other time slots and between other areas are completely independent of each other, and the respective results do not affect each other at all. Therefore, the inter-area path decision unit 150 can process the decision of the inter-area paths between a plurality of time slots and between a plurality of areas in parallel. The inter-area path decision unit 150 supplies the inter-area path to the operation plan output unit 160.

In step S760, the apparatus 100 outputs an operation plan. For example, the operation plan output unit 160 may output, as the operation plan, at least one of the result of the area allocation executed in step S720, the result of the task allocation executed in step S730, the intra-area path decided in step S740, or the inter-area path decided in step S750. As an example, the operation plan output unit 160 may output, as the operation plan, all of the area allocation, the task allocation, the intra-area path, and the inter-area path.

The apparatus 100 ends this flow in this manner, for example. Note that, in the above description, a case where the apparatus 100 executes step S750 after steps S730 and S740 has been described as an example. However, the present invention is not limited to this. The decision of the inter-area path in step S750, the result of the task allocation in step S730, and the decision of the intra-area path in step S740 are completely independent of each other, and the respective results do not affect each other at all. Therefore, the apparatus 100 may execute step S750 before steps S730 and S740, or may execute step S750 in parallel with steps S730 and S740.

As described above, there is also provided a method, which is performed by a computer, including: executing area allocation of allocating the plurality of robots 20 to a plurality of areas, which are obtained by dividing the facility 10 to be operated, based on specifications of the plurality of robots 20 and requirements of a plurality of tasks to be executed in the facility 10; and executing, for a target area which is each of the plurality of areas, task allocation of allocating an intra-area task, which is at least one task belonging to the target area among the plurality of tasks, to a target robot which is at least one robot allocated to the target area among the plurality of robots 20.

Conventionally, it is known to construct an optimization problem based on various elements, planning strategies, and the like, and solve the optimization problem to obtain a desired operation plan. However, solving the problem of the operation plan involving the multi-robot system is considered a task, called NP hard, which requires extremely high calculation cost, and it is impractical to put into operation. In addition, the calculation cost also depends on the scale of the facility 10 and the number of robots to be introduced, and for example, when a large number of robots are introduced into a large scale of the facility 10 such as a plant, it is expected that merely implementing a method for reducing a calculation load and obtaining an approximate solution is not sufficient to reach an operational status.

On the other hand, the apparatus 100 according to the present embodiment divides processing into area allocation, task allocation, intra-area path decision, and inter-area path decision. Thus, according to the apparatus 100 according to the present embodiment, it is possible to solve the problem of the operation plan involving a plurality of the robots 20, and construct a practical operation plan.

In particular, as described above, the task allocations for different areas are independent of each other. Therefore, the apparatus 100 according to the present embodiment can process the task allocations for a plurality of areas in parallel. Similarly, the decisions of intra-area paths for different time slots and different areas are independent of each other. Therefore, the apparatus 100 according to the present embodiment can process the task allocations for a plurality of time slots and a plurality of areas in parallel. Similarly, the inter-area path decisions between different time slots and between different areas are independent of each other. Therefore, the apparatus 100 according to the present embodiment can process the decisions of the inter-area path between a plurality of time slots and between a plurality of areas in parallel. Thus, according to the apparatus 100 according to the present embodiment, it is possible to solve the problem of the operation plan at high speed and construct a practical operation plan in a practical calculation time regardless of the scale of the facility 10 and the number of robots 20.

In addition, in the area allocation in one time slot, the apparatus 100 according to the present embodiment can decide, for each of the plurality of robots 20, a start point position and an end point position in the one time slot based on the results of the area allocation in other time slots. Thus, according to the apparatus 100 according to the present embodiment, since the start point position s and the end point position e are decided by the area allocation processing, the task allocation processing, the intra-area path decision processing, and the inter-area path decision processing can be made independent of each other, and flexibility can be given to execution of subsequent processing.

The apparatus 100 according to the present embodiment can also decide the intra-area path in accordance with the start point position s and the end point position e in one time slot. Thus, according to the apparatus 100 according to the present embodiment, since the result of the area allocation is followed when deciding the intra-area path, consistency of the operation plan can be secured.

In addition, the apparatus 100 according to the present embodiment can also decide the inter-area path in accordance with the end point position e in one time slot and the start point position s in the subsequent time slot. Thus, according to the apparatus 100 according to the present embodiment, since the result of the area allocation is followed when deciding the inter-area path, consistency of the operation plan can be secured.

In addition, the apparatus 100 according to the present embodiment can also decide at least one of the intra-area path or the inter-area path so as to avoid collision between the robots 20. Thus, according to the apparatus 100 according to the present embodiment, even when it is necessary to allocate a path to each of the plurality of robots 20, it is possible to avoid interference between the robots 20 and to prevent the operation from not proceeding as planned due to the interference.

In addition, the apparatus 100 according to the present embodiment can also output, as the operation plan, at least one of the area allocation, the task allocation, the intra-area path, or the inter-area path. Thus, according to the apparatus 100 according to the present embodiment, since a part or all of the plan for operating the facility 10 by the multi-robot system can be known to a user or another system, it is possible to reduce the load of the user or another system.

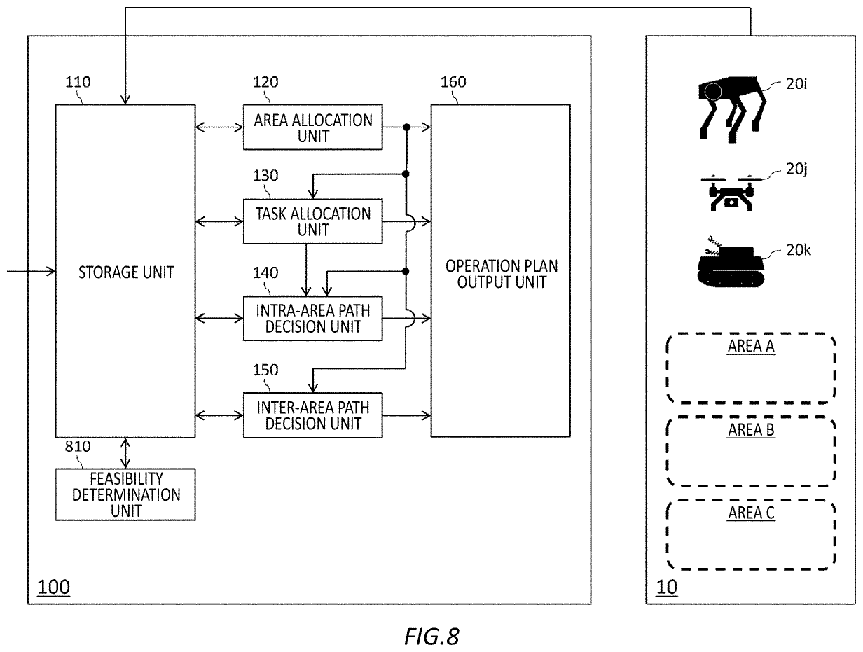

FIG. 8 illustrates an example of a block diagram of the apparatus 100 according to a first modification of the present embodiment together with the facility 10 to be operated. In the present figure, components having the same function and configuration as in FIG. 1 are given the same reference numerals, and the following describes only differing points. In the above-described embodiment, a case where the apparatus 100 stores the execution feasibility information manually created in advance has been described as an example, but in the present modification, the apparatus 100 itself determines the execution feasibility. The apparatus 100 according to the present modification further includes a feasibility determination unit 810 in addition to the functional units included in the apparatus 100 according to the above-described embodiment.

The feasibility determination unit 810 determines execution feasibility indicating whether one or more robots can execute one or more tasks based on the specification information indicating specifications in one or more robots among the plurality of robots 20 and the task information indicating the requirements of one or more tasks among the plurality of tasks. In particular, the feasibility determination unit 810 may access the storage unit 110 and determine the execution feasibility indicating whether each of the plurality of robots 20 can execute each of the plurality of tasks based on the specification information indicating the specifications in each of the plurality of robots 20 and the task information indicating the requirements of the plurality of tasks. As an example, for a task having an item of sound collection, the feasibility determination unit 810 may determine that the robot 20i and the robot 20k mounted with microphones can execute the task, while determining that the robot 20j mounted with no microphone cannot execute the task. Similarly, for a task having an item of imaging, it may be determined that the robot 20i and the robot 20j mounted with cameras can execute the task, while it may be determined that the robot 20k mounted with no camera cannot execute the task. Similarly, for a task having an item of operation of a valve, it may be determined that the robot 20k mounted with an arm can execute the task, while it may be determined that the robot 20i and the robot 20j mounted with no arm cannot execute the task.

In addition, the feasibility determination unit 810 may determine the execution feasibility further based on the environment information indicating the environment of the facility 10 for each area to which each of the plurality of tasks belongs. As an example, for a task belonging to an area where a radiation dose is equal to or greater than a threshold, it may be determined that the robot 20k having anti-explosion resistance can execute the task, while it may be determined that the robot 20i and the robot 20j having no anti-explosion resistance cannot execute the task. Similarly, for a task positioned beyond a step of 30 cm, it may be determined that the robot 20j in which a moving means is flying and the robot 20k capable of climbing over a step of 50 cm or less can execute the task, while it may be determined that the robot 20i capable of climbing over only a step of 20 cm or less cannot execute the task.

For each of the plurality of tasks, the feasibility determination unit 810 may determine the execution feasibility from a plurality of viewpoints. At this time, when the execution feasibility is divided for each viewpoint, the feasibility determination unit 810 is only required to take a logical product of results of determining that execution is possible. For example, for a task which has an item of sound collection and belongs to an area where a radiation dose is equal to or greater than the threshold, the feasibility determination unit 810 may determine that the robot 20k mounted with a microphone and having anti-explosion resistance can execute the task, while the feasibility determination unit 810 may determine that the robot 20i mounted with a microphone but having no anti-explosion resistance cannot execute the task.

For example, the feasibility determination unit 810 may supply the determination result of determining the execution feasibility in this manner to the storage unit 110. The storage unit 110 may store, as the execution feasibility information, the determination result supplied from the feasibility determination unit 810. Then, the area allocation unit 120 may execute the area allocation based on the execution feasibility determined by the feasibility determination unit 810.

As described above, the apparatus 100 according to the present modification determines whether each of the plurality of robots 20 can execute each of the plurality of tasks based on the specification information and the task information. Thus, according to the apparatus 100 according to the present modification, it is possible to avoid manually creating the execution feasibility information, and thus, it is possible to reduce the man power for determining the execution feasibility, and to construct the operation plan based on the objective execution feasibility information without depending on the deviation of the determination criterion or a determination error.

In addition, the apparatus 100 according to the present modification can also determine the execution feasibility further based on the environment information for each area to which each of the plurality of tasks belongs. Thus, according to the apparatus 100 according to the present modification, since the execution feasibility is determined based on not only the specifications of the robot 20 and the requirements of the task but also the environment for each area where the task is positioned, the execution feasibility can be determined according to actual use environment.

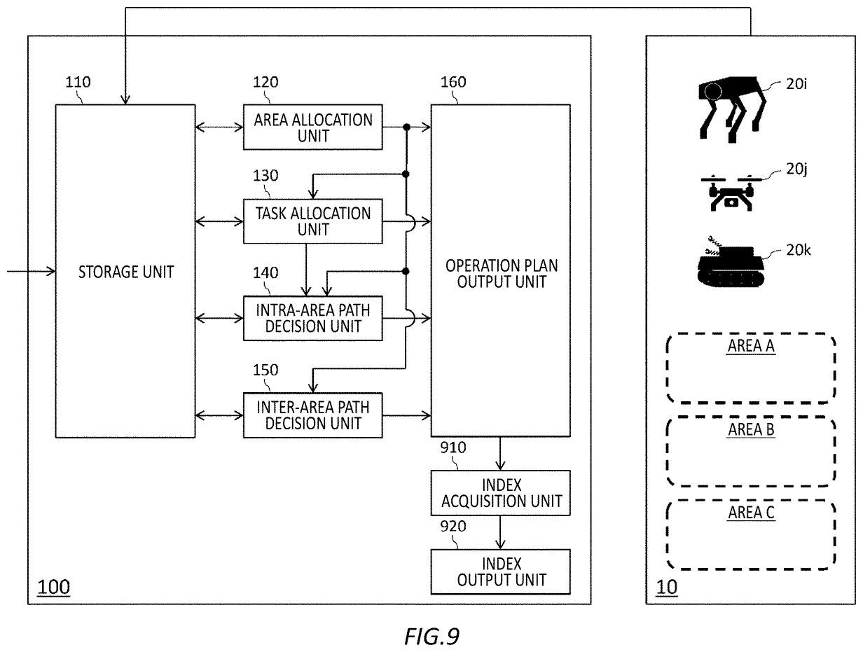

FIG. 9 illustrates an example of a block diagram of the apparatus 100 according to a second modification of the present embodiment together with the facility 10 to be operated. In the present figure, components having the same function and configuration as in FIG. 1 are given the same reference numerals, and the following describes only differing points. In the above-described embodiment, a configuration until the apparatus 100 outputs the operation plan has been described as an example, but in the present modification, the apparatus 100 further acquires an index obtained by evaluating the output operation plan and outputs the index. The apparatus 100 according to the present modification further includes an index acquisition unit 910 and an index output unit 920 in addition to the functional units included in the apparatus 100 according to the above-described embodiment. In addition, in the apparatus 100 according to the present modification, the operation plan output unit 160 outputs the operation plan to at least the index acquisition unit 910.

The index acquisition unit 910 acquires an index obtained by evaluating the operation plan in accordance with a predetermined criterion. At this time, as an example, the index acquisition unit 910 may acquire an index obtained by evaluating the operation plan in light of the running cost of the robot 20, the operation rate of the robot 20, a total operation time, and the like. Note that the index acquisition unit 910 may acquire an index evaluated by itself using an evaluation formula or an evaluation model, may acquire an index evaluated by another system, or may acquire an index evaluated manually. The index acquisition unit 910 supplies the acquired index to the index output unit 920.

The index output unit 920 outputs the index obtained by evaluating the operation plan in accordance with the predetermined criterion. The index output unit 920 may be, for example, a monitor and may display and output the index. Alternatively or in addition, the index output unit 920 may be a communication unit, and may transmit and output the index to another functional unit or another apparatus. Alternatively or additionally, the index output unit 920 may be a printer, and may print out the index. Alternatively or additionally, the index output unit 920 may be a speaker and may output the index by voice.

As described above, the apparatus 100 according to the present modification acquires and outputs the index obtained by evaluating the operation plan. Thus, according to the apparatus 100 according to the present modification, it is possible to inform the user or another system of not only the constructed operation plan but also how highly the operation plan is evaluated.

In addition, the apparatus 100 according to the present modification may construct a plurality of operation plans, and acquire and output an index for each of the plurality of operation plans. Thus, according to the apparatus 100 according to the present modification, it is possible to determine a suitable arrangement of a plurality of robots 20 by repeatedly solving the operation plan problem while adjusting the arrangement of the robots 20, and thus, it is also possible to cause the apparatus to function as a consulting support tool for robot introduction.

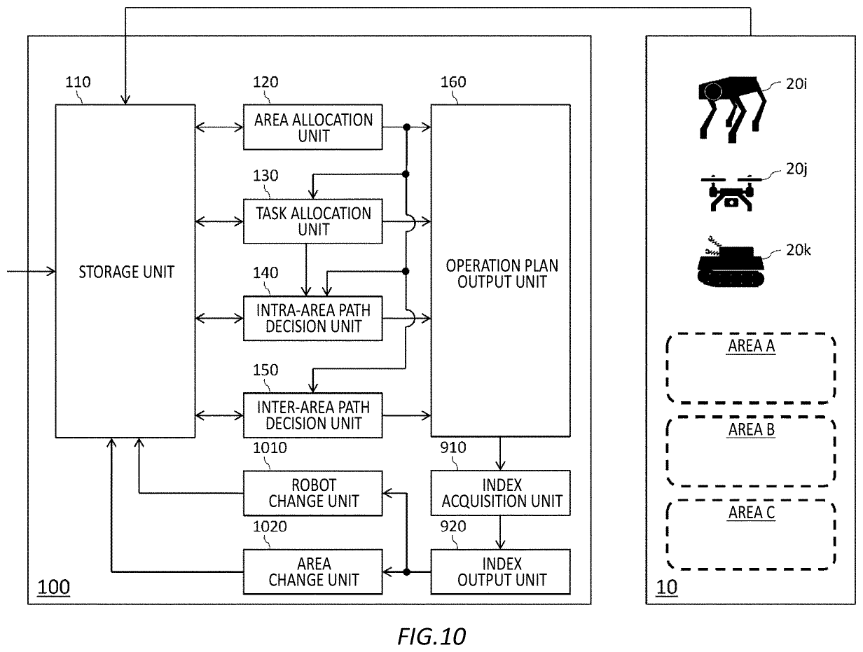

FIG. 10 illustrates an example of a block diagram of the apparatus 100 according to a third modification of the present embodiment together with the facility 10 to be operated. In the present figure, components having the same function and configuration as in FIG. 9 are given the same reference numerals, and the following describes only differing points. In the above-described modification, a configuration until the apparatus 100 outputs the index has been described as an example, but in the present modification, the apparatus 100 further changes at least one of the combination of the robots 20 or the division of the facility 10 into a plurality of areas based on the output index.

In other words, a case where the apparatus 100 constructs the operation plan on a premise that the combination of the robots 20 is fixed (in the above description, it has already been decided to introduce three robots 20 of the robot 20i, the robot 20j, and the robot 20k into the facility 10) and the division of the facility 10 into the plurality of areas is fixed (in the above description, the facility 10 is divided in advance into three areas of the area A, the area B, and the area C) has been described so far. However, in the present modification, the apparatus 100 changes at least one of these based on the output index. The apparatus 100 according to the present modification further includes a robot change unit 1010 and an area change unit 1020 in addition to the functional units included in the apparatus 100 according to the above-described modification. In addition, in the apparatus 100 according to the present modification, the index output unit 920 supplies the index to the robot change unit 1010 and the area change unit 1020.

The robot change unit 1010 changes at least one of the number or the specifications of the plurality of robots 20 based on the index obtained by evaluating the operation plan in accordance with the predetermined criterion. At this time, for example, the robot change unit 1010 may change only the number of robots 20 to be introduced into the facility 10, may change only the specifications of the robots to be introduced into the facility 10 without changing the number, or may change both the number and the specifications. As an example, when the total operation time is long and the index does not satisfy the predetermined criterion, the robot change unit 1010 may increase the number of the robots 20 to be introduced into the facility 10. At this time, for example, the robot change unit 1010 may add a robot having the same specification as that of an existing robot already included in the plurality of robots 20 (for example, a robot 20i(2) having the same specification as that of the robot 20i), or may add a new robot (for example, a robot 20I) having a specification different from that of the existing robot. In addition, when the operation rate of one robot 20 is extremely high and the index does not satisfy the predetermined criterion, the robot change unit 1010 may change the specification of the robot to be introduced into the facility 10. At this time, for example, the robot change unit 1010 may change at least one of existing robots already included in the plurality of robots 20 to a robot having the same specification as that of another existing robot (for example, change the robot 20i to a robot 20j(2) having the same specification as that of the robot 20j), or may change the at least one to a new robot having a different specification from that of the existing robot (for example, change the robot 20i to the robot 20I).

When at least one of the number or the specifications of the plurality of robots 20 is changed, the robot change unit 1010 notifies the storage unit 110 of the change. In response to this, the storage unit 110 updates the stored information on the robot 20 (for example, specification information) to new information on the plurality of robots 20. Then, the area allocation unit 120 reallocates, to the plurality of areas, the plurality of new robots 20 of which at least one of the number or the specifications has been changed. In response to this, the task allocation unit 130 re-executes the task allocation, the intra-area path decision unit 140 redecides the intra-area path, and the inter-area path decision unit 150 redecides the inter-area path. For example, the apparatus 100 reconstructs the operation plan in this manner, and the operation plan output unit 160 outputs the reconstructed operation plan.

The area change unit 1020 changes at least one of the number of areas or the boundary of the plurality of areas based on the index obtained by evaluating the operation plan in accordance with the predetermined criterion. At this time, for example, the area change unit 1020 may change only the number of areas, may change only the boundary without changing the number of areas, or may change both the number of areas and the boundary. As an example, when the total operation time is long and the index does not satisfy the predetermined criterion, the area change unit 1020 may increase the number of areas. At this time, for example, the area change unit 1020 may change a plurality of areas so as to redivide the facility 10, which has been divided into three areas, into four areas. In addition, when the operation rate of one robot 20 is extremely high and the index does not satisfy the predetermined criterion, the area change unit 1020 may change the boundary for dividing the facility 10 into the plurality of areas. At this time, for example, the area change unit 1020 may change all of the boundary to redivide the facility 10 into three areas of an area D, an area E, and an area F, or may change a part of the boundary to redivide the facility 10 into three areas of the area A, the area D, and the area E.

When at least one of the number of areas or the boundary of the plurality of areas is changed, the area change unit 1020 notifies the storage unit 110 of the change. Note that such a notification may include information indicating the position of the boundary. In response to this, the storage unit 110 reorganizes the stored task information for each of a plurality of new areas, and updates the intra-area task. Then, the area allocation unit 120 reallocates the plurality of robots 20 to the plurality of new areas of which at least one of the number of areas or the boundary has been changed. In response to this, the task allocation unit 130 re-executes the task allocation, the intra-area path decision unit 140 redecides the intra-area path, and the inter-area path decision unit 150 redecides the inter-area path. For example, the apparatus 100 reconstructs the operation plan in this manner, and the operation plan output unit 160 outputs the reconstructed operation plan in accordance with the plurality of new areas.

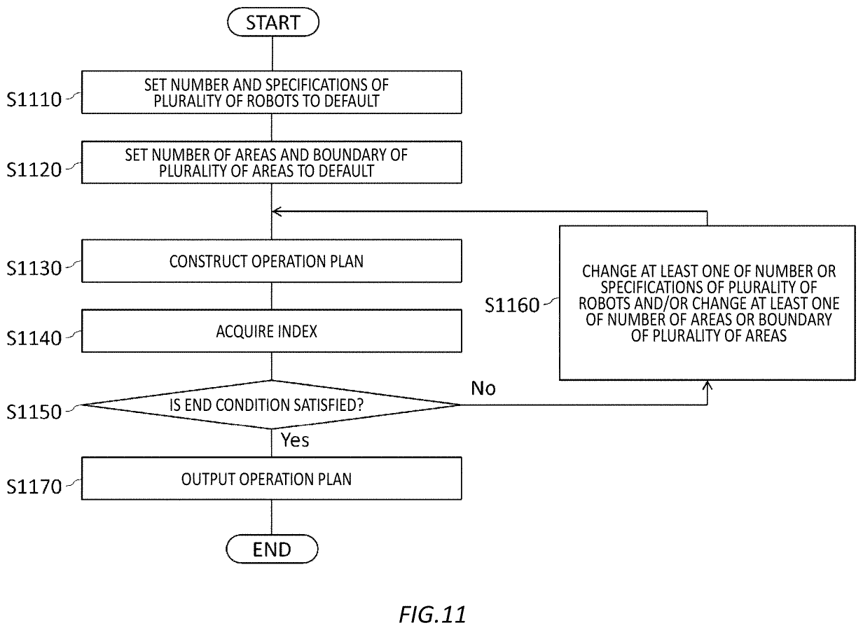

FIG. 11 illustrates an example of a flow diagram of a method executed by the apparatus 100 according to the third modification of the present embodiment to repeatedly construct the operation plan.

In step S1110, the apparatus 100 sets the number and specifications of the plurality of robots 20 to default. As an example, the apparatus 100 may set the plurality of robots 20 as three robots 20 of the robot 20i, the robot 20j, and the robot 20k. In response to this, the storage unit 110 may store, as the specification information, information indicating the specification in each of the robot 20i, the robot 20j, and the robot 20k.

In step S1120, the apparatus 100 sets the number of areas and the boundary of the plurality of areas to default. As an example, the apparatus 100 may set the plurality of areas such that facility 10 is divided into three areas of the area A, the area B, and the area C. In response to this, the storage unit 110 organizes the stored task information for each of the area A, the area B, and the area C, and stores the organized task information as an intra-area task for each of the area A, the area B, and the area C.

In response to this, the storage unit 110 may update the execution feasibility information. At this time, the storage unit 110 may update the execution feasibility information to be stored to information created manually, or may update the execution feasibility information based on the determination result obtained by the redetermination of the feasibility determination unit 810.

In step S1130, the apparatus 100 constructs an operation plan. The construction of the operation plan is as described above.

In step S1140, the apparatus 100 acquires an index. The acquisition of the index is also as described above.

In step S1150, the apparatus 100 determines whether an end condition is satisfied. For example, the apparatus 100 determines whether the index acquired in step S1140 satisfies a predetermined criterion. When it is determined that the index does not satisfy the predetermined criterion (No), the apparatus 100 advances the processing to step S1160.

In step S1160, the apparatus 100 changes at least one of the number or specifications of the plurality of robots 20, and/or changes at least one of the number of areas or the boundary of the plurality of areas. At this time, as described above, the robot change unit 1010 may change only the number of robots 20 to be introduced into the facility 10, may change only the specifications of the robots to be introduced into the facility 10 without changing the number, or may change both the number and the specifications. In addition, at this time, as described above, the area change unit 1020 may change only the number of areas of the plurality of areas, may change the boundary without changing the number of areas, or may change both the number of areas and the boundary.

Then, the apparatus 100 returns the processing to step S1130 and continues the flow. That is, the apparatus 100 updates various types of information stored in the storage unit 110, and reconstructs the operation plan based on new information.

When it is determined in step S1150 that the index satisfies the predetermined criterion (Yes), the apparatus 100 advances the processing to step S1170.

In step S1170, the apparatus 100 outputs an operation plan. For example, the operation plan output unit 160 outputs the operation plan for which it is determined in step S1150 that the index satisfies the predetermined criterion.

Note that, in the above description, a case where in step S1150, the apparatus 100 determines whether the end condition is satisfied, depending on whether the index satisfies the predetermined criterion has been described as an example, but the present invention is not limited thereto.

In step S1150, the apparatus 100 may determine whether the end condition is satisfied, depending on whether the number of times of constructing the operation plan has reached a predetermined number of times. Alternatively, in step S1150, the apparatus 100 may determine whether the end condition is satisfied, depending on whether an elapsed time from the start of this flow has reached a predetermined time. In this case, the apparatus 100 may repeat the construction of the operation plan and the acquisition of the index a plurality of times while executing the reconfiguration of the robot 20/the redivision of the facility 10 according to a predetermined rule or randomly, regardless of whether the index satisfies the criterion. Then, the apparatus 100 may select the operation plan, which has become the best in index, from a plurality of operation plans constructed until the end condition is satisfied and output the selected operation plan.

As described above, the apparatus 100 according to the present modification changes at least one of the number or the specification of a plurality of robots 20 based on the index obtained by evaluating the operation plan, reconstructs the operation plan, and outputs the reconstructed operation plan. Thus, according to the apparatus 100 according to the present modification, it is possible to determine the suitable number or specifications of the plurality of robots 20 by repeatedly solving the operation plan problem while adjusting the number or the specifications of the robots 20.

In addition, the apparatus 100 according to the present modification changes at least one of the number of areas or boundary of the plurality of areas based on the index obtained by evaluating the operation plan, reconstructs the operation plan, and outputs the reconstructed operation plan. Thus, according to the apparatus 100 according to the present modification, it is possible to determine the suitable number of areas or boundary of the plurality of areas by repeatedly solving the operation plan problem while adjusting the number of areas or the boundary. As described above, the apparatus 100 according to the present modification can determine the number or specifications of the robots 20 and how to suitably set the number of areas or the boundary. Thus, according to the apparatus 100 according to the present modification, it is possible to reduce man-hours for setting and to clarify whether the setting is suitable.

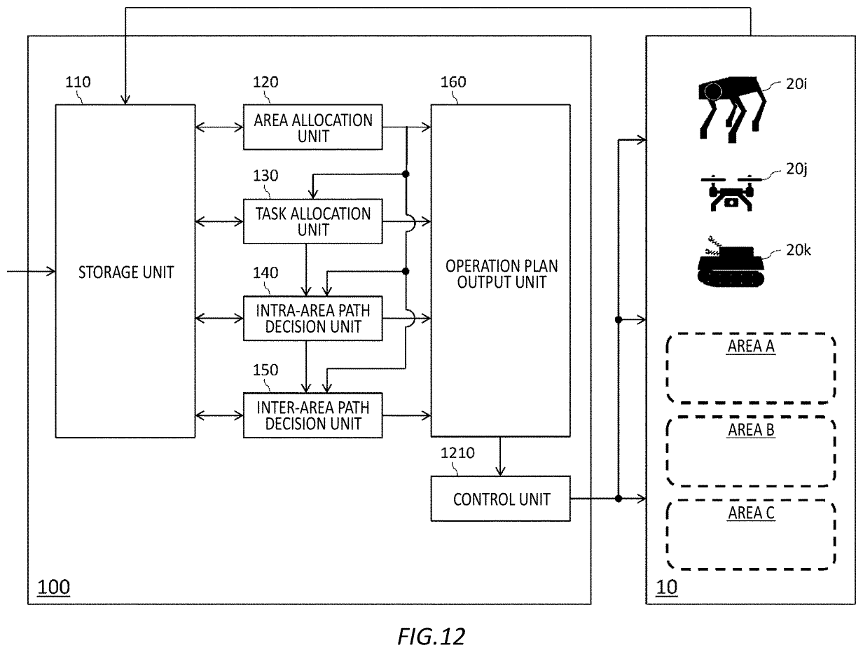

FIG. 12 illustrates an example of a block diagram of the apparatus 100 according to a fourth modification of the present embodiment together with the facility 10 to be operated. In the present figure, components having the same function and configuration as in FIG. 1 are given the same reference numerals, and the following describes only differing points. In the above-described embodiment, a configuration until the apparatus 100 outputs the operation plan has been described as an example, but in the present modification, the apparatus 100 further controls the plurality of robots 20 in accordance with the output operation plan. The apparatus 100 according to the present modification further includes a control unit 1210 in addition to the functional units included in the apparatus 100 according to the above-described embodiment. In addition, in the apparatus 100 according to the present modification, the operation plan output unit 160 outputs the operation plan to at least the control unit 1210.

The control unit 1210 controls the plurality of robots 20 in accordance with the operation plan. As described above, the operation plan output from the operation plan output unit 160 may include at least one of the area allocation, the task allocation, the intra-area path, or the inter-area path. Therefore, the control unit 1210 may control the plurality of robots 20 such that a target robot is arranged in a target area in accordance with the area allocation. In addition, the control unit 1210 may control the plurality of robots 20 such that the target robot executes the intra-area task in accordance with the task allocation. In addition, the control unit 1210 may control the plurality of robots 20 such that the target robot moves in the area in accordance with the intra-area path. In addition, the control unit 1210 may control the plurality of robots 20 such that the plurality of robots 20 moves between areas in accordance with the inter-area path.

The term “control” as used herein may include the indirect control of the robot 20 by controlling a controller which controls the robot 20, in addition to the direct control of the robot 20.

As described above, the apparatus 100 according to the present modification controls the plurality of robots 20 in accordance with the operation plan. Thus, the apparatus 100 according to the present modification is used not only to construct the operation plan but also to function as a control apparatus, and thus, it is possible to apply the constructed operation plan to actual control.

Various embodiments of the present invention may be described with reference to flowcharts and block diagrams whose blocks may represent (1) stages of processes in which operations are performed or (2) sections of apparatuses responsible for performing operations. Certain stages and sections may be implemented by dedicated circuit, programmable circuit supplied with computer readable instructions stored on computer readable media, and/or processors supplied with computer readable instructions stored on computer readable media. Dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element such as a flip-flop, a register, a field programmable gate array (FPGA) and a programmable logic array (PLA), and the like.

A computer readable medium may include any tangible device that can store instructions to be executed by a suitable device, and as a result, the computer readable medium having instructions stored thereon includes an article of manufacture including instructions which can be executed in order to create means for performing operations designated in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code written in any combination of one or more programming languages, including an object oriented programming language such as Smalltalk (registered trademark), JAVA (registered trademark), C++, or the like; and a conventional procedural programming language such as a “C” programming language or a similar programming language.

Computer-readable instructions may be provided to a processor of a general-purpose computer, special purpose computer, or other programmable data processing apparatuses, or to programmable circuitry, locally or via a local area network (LAN), wide area network (WAN) such as the Internet, or the like, to execute the computer-readable instructions to create means for performing operations specified in the flowcharts or block diagrams. Examples of the processor include a computer processor, a processing unit, a microprocessor, a digital signal processor, a controller, a microcontroller, and the like.

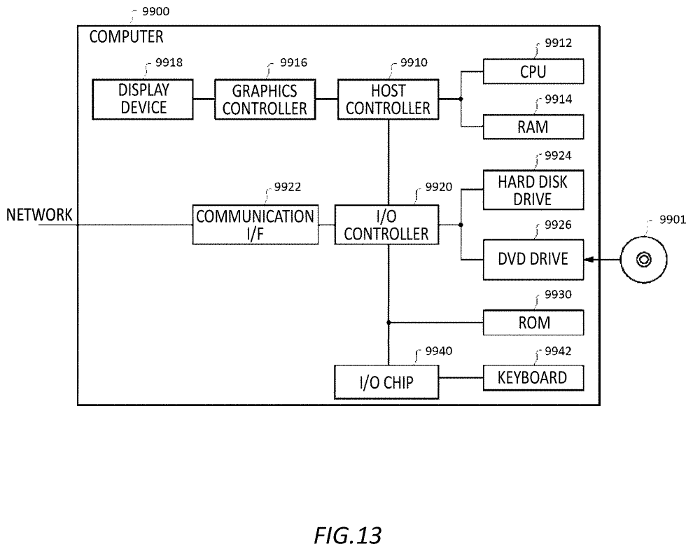

FIG. 13 illustrates an example of a computer 9900 in which a plurality of aspects of the present invention may be embodied in whole or in part. A program that is installed in the computer 9900 can cause the computer 9900 to function as or execute operations associated with the apparatus of the embodiment of the present invention or one or more sections of the apparatus, and/or cause the computer 9900 to execute the processes of the embodiment of the present invention or steps thereof. Such a program may be executed by a CPU 9912 so as to cause the computer 9900 to execute certain operations associated with some or all of the flowcharts and the blocks in the block diagrams described herein.

The computer 9900 according to the present embodiment includes the CPU 9912, a RAM 9914, a graphics controller 9916 and a display device 9918, which are mutually connected by a host controller 9910. The computer 9900 further includes input/output units such as a communication interface 9922, a hard disk drive 9924, a DVD drive 9926 and an IC card drive, which are connected to the host controller 9910 via an input/output controller 9920. The computer also includes legacy input/output units such as a ROM 9930 and a keyboard 9942, which are connected to the input/output controller 9920 via an input/output chip 9940.

The CPU 9912 operates according to programs stored in the ROM 9930 and the RAM 9914, thereby controlling each unit. The graphics controller 9916 acquires image data generated by the CPU 9912 on a frame buffer or the like provided in the RAM 9914 or in itself, and causes the image data to be displayed on the display device 9918.

The communication interface 9922 communicates with other electronic devices via a network. The hard disk drive 9924 stores programs and data that are used by the CPU 9912 within the computer 9900. The DVD drive 9926 reads programs or data from a DVD-ROM 9901, and provides the hard disk drive 9924 with the programs or data via the RAM 9914. The IC card drive reads the programs and the data from the IC card, and/or writes the programs and the data to the IC card.

The ROM 9930 stores therein a boot program or the like executed by the computer 9900 at the time of activation, and/or a program depending on the hardware of the computer 9900. The input/output chip 9940 may also connect various input/output units via a parallel port, a serial port, a keyboard port, a mouse port or the like to the input/output controller 9920.

A program is provided by a computer-readable medium such as the DVD-ROM 9901 or the IC card. The program is read from the computer-readable medium, installed into the hard disk drive 9924, RAM 9914, or ROM 9930, which are also examples of a computer-readable medium, and executed by CPU 9912. The information processing described in these programs is read into the computer 9900, resulting in cooperation between a program and the above-mentioned various types of hardware resources. An apparatus or method may be constituted by realizing the operation or processing of information in accordance with the usage of the computer 9900.

For example, when communication is performed between the computer 9900 and an external device, the CPU 9912 may execute a communication program loaded onto the RAM 9914 to instruct communication processing to the communication interface 9922, based on the processing described in the communication program. The communication interface 9922, under control of the CPU 9912, reads transmission data stored on a transmission buffer area provided in a recording medium such as the RAM 9914, the hard disk drive 9924, DVD-ROM 9901, or the IC card, and transmits the read transmission data to a network or writes reception data received from a network to a reception buffer area or the like provided on the recording medium.

Also the CPU 9912 may cause all or a necessary portion of a file or a database to be read into the RAM 9914, wherein the file or the database has been stored in an external recording medium such as the hard disk drive 9924, the DVD drive 9926 (DVD-ROM 9901), the IC card, etc., and perform various types of processing on the data on the RAM 9914. The CPU 9912 then writes back the processed data to the external recording medium.

Various types of information such as various types of programs, data, tables, and databases may be stored in a recording medium and subjected to information processing. The CPU 9912 may perform various types of processing on the data read from the RAM 9914, which includes various types of operations, information processing, condition judging, conditional branch, unconditional branch, search/replacement of information, etc., as described throughout this disclosure and designated by an instruction sequence of programs, and writes the result back to the RAM 9914. Also the CPU 9912 may search for information in a file, a database, etc., in the recording medium. For example, when a plurality of entries, each having an attribute value of a first attribute associated with an attribute value of a second attribute, are stored in the recording medium, the CPU 9912 may search for an entry matching the condition whose attribute value of the first attribute is designated, from among the plurality of entries, and read the attribute value of the second attribute stored in the entry, thereby acquiring the attribute value of the second attribute associated with the first attribute satisfying the predetermined condition.

The above-described program or software modules may be stored in the computer-readable medium on or near the computer 9900. Also a recording medium such as a hard disk or a RAM provided in a server system connected to a dedicated communication network or the Internet can be used as the computer-readable medium, thereby providing the program to the computer 9900 via the network.

While the present invention has been described by way of the embodiments, the technical scope of the present invention is not limited to the above described embodiments. It is apparent to persons skilled in the art that various alterations or improvements can be made to the above described embodiments. It is also apparent from the description of the claims that embodiments added with such alterations or improvements can be included in the technical scope of the present invention.

The operations, procedures, steps, and stages of each process performed by an apparatus, system, program, and method illustrated in the claims, embodiments, or diagrams can be performed in any order as long as the order is not indicated by “prior to,” “before,” or the like and as long as the output from a previous process is not used in a later process. Even if the operation flow is described by using phrases such as “first” or “next” in the scope of the claims, specification, or drawings, it does not necessarily mean that the process must be performed in this order.

### DESCRIPTION OF REFERENCE NUMERALS

10: facility;
20: robot;
100: apparatus;
110: storage unit;
120: area allocation unit;
130: task allocation unit;
140: intra-area path decision unit;
150: inter-area path decision unit;
160: operation plan output unit;
810: feasibility determination unit;
910: index acquisition unit;
920: index output unit;
1010: robot change unit;
1020: area change unit;
1210: control unit;
9900: computer;
9901: DVD-ROM;
9910: host controller;
9912: CPU;
9914: RAM;
9916: graphics controller;
9918: display device;
9920: input/output controller;
9922: communication interface;
9924: hard disk drive;
9926: DVD drive;
9930: ROM;
9940: input/output chip; and
9942: keyboard.

1. An apparatus comprising:
an area allocation unit which executes area allocation of allocating a plurality of robots to a plurality of areas, which are obtained by dividing a facility to be operated, on a basis of specifications of the plurality of robots and requirements of a plurality of tasks to be executed in the facility; and
a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots.

2. The apparatus according to claim 1, further comprising an intra-area path decision unit which decides an intra-area path, along which the target robot is moved in the target area, on a basis of a result of the task allocation.

3. The apparatus according to claim 2, further comprising an inter-area path decision unit which decides an inter-area path, along which the plurality of robots are moved between areas of the plurality of areas, on a basis of a result of the area allocation.

4. The apparatus according to claim 3, wherein in the area allocation in one time slot, the area allocation unit decides, for each of the plurality of robots, a start point position and an end point position in the one time slot on a basis of results of the area allocation in other time slots.

5. The apparatus according to claim 4, wherein the intra-area path decision unit decides the intra-area path in accordance with the start point position and the end point position in the one time slot.

6. The apparatus according to claim 5, wherein the inter-area path decision unit decides the inter-area path in accordance with the end point position in the one time slot and the start point position in a subsequent time slot.

7. The apparatus according to claim 1, further comprising
a feasibility determination unit which determines, on a basis of specification information indicating specifications in one or more robots among the plurality of robots and task information indicating requirements of one or more tasks among the plurality of tasks, execution feasibility indicating whether the one or more robots are capable of executing the one or more tasks, wherein
the area allocation unit executes the area allocation on a basis of the execution feasibility.

8. The apparatus according to claim 7, wherein the feasibility determination unit determines, on a basis of specification information indicating a specification in each of the plurality of robots and task information indicating requirements of the plurality of tasks, execution feasibility indicating whether each of the plurality of robots is capable of executing each of the plurality of tasks.

9. The apparatus according to claim 8, wherein the feasibility determination unit determines the execution feasibility further on a basis of environment information indicating environment of the facility for each area to which each of the plurality of tasks belongs.

10. The apparatus according to claim 3, further comprising an operation plan output unit which outputs, as an operation plan, at least one of a result of the area allocation, a result of the task allocation, the intra-area path, or the inter-area path.

11. The apparatus according to claim 10, further comprising an index output unit which outputs an index obtained by evaluating the operation plan in accordance with a predetermined criterion.

12. The apparatus according to claim 10, further comprising
a robot change unit which changes at least one of a number or specifications of the plurality of robots on a basis of an index obtained by evaluating the operation plan in accordance with a predetermined criterion, wherein
the area allocation unit reallocates, to the plurality of areas, a plurality of new robots of which at least one of the number or the specifications has been changed.

13. The apparatus according to claim 10, further comprising
an area change unit which changes at least one of a number of areas or a boundary of the plurality of areas on a basis of an index obtained by evaluating the operation plan in accordance with a predetermined criterion, wherein
the area allocation unit reallocates the plurality of robots to a plurality of new areas of which at least one of the number of areas or the boundary has been changed.

14. The apparatus according to claim 10, further comprising a control unit which controls the plurality of robots in accordance with the operation plan.

15. A method performed by a computer, comprising:
executing area allocation of allocating a plurality of robots to a plurality of areas, which are obtained by dividing a facility to be operated, on a basis of specifications of the plurality of robots and requirements of a plurality of tasks to be executed in the facility; and
executing, for a target area which is each of the plurality of areas, task allocation of allocating an intra-area task, which is at least one task belonging to the target area among the plurality of tasks, to a target robot which is at least one robot allocated to the target area among the plurality of robots.

16. A non-transitory computer readable medium having recorded thereon a program that, when executed by a computer, causes the computer to function as:
an area allocation unit which executes area allocation of allocating a plurality of robots to a plurality of areas, which are obtained by dividing a facility to be operated, on a basis of specifications of the plurality of robots and requirements of a plurality of tasks to be executed in the facility; and
a task allocation unit which executes, for a target area which is each of the plurality of areas, task allocation of allocating an intra-area task, which is at least one task belonging to the target area among the plurality of tasks, to a target robot which is at least one robot allocated to the target area among the plurality of robots.

17. The apparatus according to claim 1, further comprising an inter-area path decision unit which decides an inter-area path, along which the plurality of robots are moved between areas of the plurality of areas, on a basis of a result of the area allocation.

18. The apparatus according to claim 17, wherein in the area allocation in one time slot, the area allocation unit decides, for each of the plurality of robots, a start point position and an end point position in the one time slot on a basis of results of the area allocation in other time slots, and wherein
the inter-area path decision unit decides the inter-area path in accordance with the end point position in the one time slot and the start point position in a subsequent time slot.

19. The apparatus according to claim 1, wherein in the area allocation in one time slot, the area allocation unit decides, for each of the plurality of robots, a start point position and an end point position in the one time slot on a basis of results of the area allocation in other time slots.

20. The apparatus according to claim 2, wherein the intra-area path decision unit decides the intra-area path in accordance with a start point position and an end point position in one time slot.
